(19) United States
(12) Patent Application Publication
(10) Pub. No.: US 2005/0032569 A1
(43) Pub. Date: Feb. 10, 2005

(54) Methods and system for interactive lottery game

(76) Inventor: Jerome Turk, Del Mar, CA (US)

Correspondence Address: TRASK BRITT, P.O. BOX 2550, SALT LAKE CITY, UT, 84110, US

(21) Appl. No.: 10/635,106

(22) Filed: Aug. 5, 2003

(51) Int. Cl. G06F 19/00; G06F 17/00

(52) U.S. Cl. 463/17

(57) ABSTRACT

A gaming activity includes a random drawing determined at least in part by an outcome of at least one separate event is disclosed. To play the gaming activity, a player selects an outcome of the at least one separate event. Once the outcome has been determined in the separate event, players that selected the outcome of the separate event are qualified for participation in the random drawing. Winners selected in the random drawing may receive an award and are eligible to participate in subsequent random drawings, where prizes may be awarded in each subsequent random drawing. Systems and methods for conducting the gaming activity are also disclosed.

### RELATED APPLICATION

Pursuant to the provisions of 35 U.S.C. 119(e), this application claims the benefit of the filing date of U.S. Provisional Application Ser. No. 60/401,284, filed Aug. 5, 2002 and entitled METHODS AND SYSTEM FOR INTERACTIVE LOTTERY GAME, which is incorporated by reference herein in its entirety.

### BACKGROUND OF THE INVENTION

1. Field of the Invention

The present invention relates generally to gaming systems and methods. More particularly, a gaming activity of the present invention includes a lottery type game conducted in concert with games played in a league. More specifically, the lottery type game played in concert with a league is provided as a promotional activity in conjunction with a business enterprise.

2. State of the Art

Many different businesses, including without limitation various vendors, casinos, casino web sites, and other gaming establishments, seek to attract potential customers using promotional activities. For instance, the business may give away something of value to the potential customer or enter the potential customer in a contest in an attempt to attract the customer to the business. In one example, a vendor may give the potential customer a free gift when the potential customer enters the vendor's business location. Other promotional activities include a random contest where the potential customer is automatically entered into a lottery or a raffle upon entering the business or upon the purchase of merchandise. These various promotional activities serve as powerful incentives that function to attract potential customers to the business.

Although traditional promotional activities are a useful marketing tool, these promotional activities suffer from inherent drawbacks. For instance, a business must invest money to provide the free gift to each potential customer who comes in the door with no guarantee that the customer will spend money at the business. Alternatively, a business that conducts a free lottery must invest time and money into organizing the lottery, ensuring the lottery is run fair, and providing a prize with sufficient value to entice the potential customers. Unfortunately, the promotional activities provide little entertainment to the potential customer because the free gift is often trivial in value or the odds of the potential customer winning the lottery are very small. Thus, the potential customers may not partake in the promotional activity or may take part in the promotional activity, but not become a customer to the business. Also, many of the promotional activities are disadvantaged by the fact that they occur at a specified time or last a short time period, when some potential customers may not be able to attend.

Another example of a promotional gaming method is disclosed in U.S. Pat. No. 5,080,364, issued Jan. 14, 1992 to Seidman (hereinafter “Seidman”). Seidman discloses a promotional game where tokens are distributed to prospective patrons of a gaming establishment. The tokens each include a code which may be read by a machine. If the code on the token matches a predetermined winning code, then the patron wins a prize. The tokens may be given away with merchandise purchased by the prospective patrons or the code may be contained within a Universal Product Code (JPC) symbol on an item of merchandise purchased by the customer. The machine that reads the code may be located at a gaming establishment, such as a casino, such that the patron needs to visit the gaming establishment to see if they have won a prize, thus attracting the potential customer to the gaming establishment.

U.S. Pat. No. 5,855,369, issued Jan. 5, 1999 to Lieberman (hereinafter “Lieberman”) also discloses a promotional gaming method that uses a game of chance. In the gaming method disclosed in Lieberman, entry forms with a mock bar code and a depiction of a promoted product are distributed to participants in the game. A participant places self-identifying information and a UPC code number corresponding to the promoted product on the entry form. The participant deposits the completed entry form into a receptacle, from which an operator of the promotional activity may collect entry forms from a plurality of participants. The operator then randomly determines which participant(s) are selected to win a prize.

Although the disclosed promotional gaming activities disclose methods of marketing and promoting designed to attract potential customers, the disclosed promotional gaming activities are limited to a game of chance in which one or more winners are determined at a single time. Further, the disclosed promotional gaming activities do not provide the player with an interactive gaming experience. Thus, a promotional gaming activity that affords the player multiple opportunities to win in an on going promotional activity and allows the player to actively make selections that determines, at least in part, whether the player wins would be an improvement in the art.

### BRIEF SUMMARY OF THE INVENTION

The present invention is directed to a method of conducting a gaming activity. The gaming activity includes providing a player present at a business enterprise, such as a casino, with an opportunity to participate in the gaming activity, where the opportunity includes allowing the player to select a participant in a separate game, such as a sporting event, that the player believes will win the separate game. If the participant selected by the player wins the game, the player is then qualified to participate in a random drawing and a winner is determined in the random drawing. The result of the random drawing may be an award, an opportunity to participate in a subsequent random drawing, or both.

The present invention also includes a method of conducting a gaming activity where a player present at a business enterprise, such as a casino, participates by selecting a participant in a league to win a league championship. If the participant selected by the player wins the league championship, the player is qualified for participation in a first random drawing. The random drawing is conducted and prizes are awarded to winners of the drawing.

A system for conducting a gaming activity is also disclosed. The system includes entry forms configured for receiving identifiable information from a player of the gaming activity. The system also includes at least one pair of random selection means configured for receiving the entry forms and determining an outcome of a first random drawing. The system further comprises a second random selection means configured for receiving the entry forms and conducting a second random drawing. A third random selection means is also included in the system, where the third random selection means is configured for receiving entry forms and conducting a third random drawing.

### BRIEF DESCRIPTION OF THE SEVERAL VIEWS OF THE DRAWINGS

The nature of the present invention as well as other embodiments of the present invention may be more clearly understood by reference to the following detailed description of the invention, to the appended claims, and to the several drawings herein, wherein:

FIG. 1 is a diagram of a system of drums used in the gaming activities of the present invention;

FIG. 2 is a flowchart depicting play of the gaming activities of the present invention;

FIG. 3A is a front view of a team drum;

FIG. 3B is a side view of the team drum of FIG. 3A; and

FIG. 4 is a diagram of the system used to conduct the gaming activities of the present invention.

### DETAILED DESCRIPTION OF THE INVENTION

The present invention relates generally to gaming systems and methods. More specifically, a gaming activity of the present invention relates to a lottery game used as a promotional activity to attract players to a particular location, such as a casino. In the following detailed description, the lottery game is combined with a separate event, such as games played within a sports league, wherein results of the games played in the sports league determine, at least in part, winners of the lottery game.

It will be appreciated by those of ordinary skill in the art that the embodiments described herein, while illustrating certain embodiments, are not intended to so limit the invention or the scope of the appended claims. Those of ordinary skill in the art will understand that various combinations or modifications of the embodiments presented herein may be made without departing from the scope of the invention. For instance, it will be appreciated that the gaming activities and methods described herein, while particularly suited for attracting players to gaming establishments, may also be adapted for attracting potential customers to other businesses using promotional marketing methods. Embodiments of the present invention directed to gaming activities used in gaming establishments are also within the scope of the present invention.

The gaming activities described herein are designed to be performed on a gaming system with a sports theme. It will be appreciated by those of ordinary skill in the art that devices and materials used to play and promote the gaming activities described herein may be decorated or configured such that the sights and sounds produced by the gaming system have a distinct theme or motif The gaming activities and systems described herein may be configured such that the impression, or a feel, experienced by a player of the gaming activity is that of a sporting event. For instance, the embodiments of the gaming activities described herein may be configured such that the devices of the gaming system are decorated with sights of a professional football league, such that the player experiences a football “feel.” For example, football goal posts may be used for promotional signs, a football scoreboard may be used to relate gaming information to players, or football shapes may be included in the promotional materials. Additionally, indicia of professional teams may be incorporated into the gaming activities and systems described herein such that players may cheer for their favorite team. In alternative gaming activities, the devices and materials used in the systems to conduct the gaming activities may be configured to represent other sports including, without limitation, baseball, basketball, hockey, soccer, golf, car racing, horse racing, or any other sporting activity.

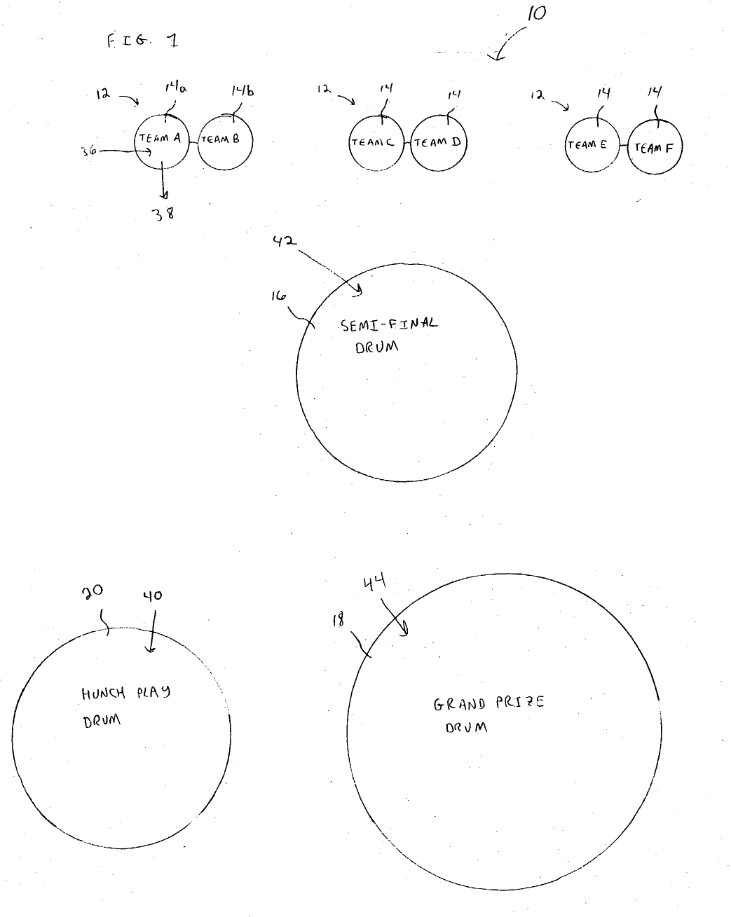

Referring now to drawing FIG. 1, there is shown, generally at 10, a diagrammatic representation of a system of drums used in the gaming activities of the present invention. The drums of the present invention may comprise “lottery-type” drums that are configured to receive, randomize (e.g., by mixing), and facilitate the random selection of entry tickets from the drums. As illustrated, the system 10 includes three different pairs of team drums at 12, wherein each pair 12 comprises two team drums 14 and represents an upcoming competition between the two teams whose identifying indicia appears on the team drums 12. Although there are three pairs 12 of team drums 14 illustrated in FIG. 1, it will be apparent by those of ordinary skill in the art that there may be any number of pairs 12 of team drums 14 in the system 10 of the present invention, ranging from one pair 12 to hundreds of pairs 12. Since the embodiments described herein are directed to football, the number of pairs 12 of team drums 14 may be determined by a number of games that are played each week in a football league. For instance, there may be fifteen games in one week of the football league. Therefore, fifteen pairs 12 of team drums 14 may be used for that week, where each pair 12 of team drums 14 represents each game. As illustrated, each team drum 14 in the pair 12 represents two teams that will play each other in one week. For example, team drum 14a represents Team A and team drum 14b represents Team B, wherein Team A plays Team B. In keeping with the football theme of the present invention, each team drum 14 may be decorated with indicia representing a particular football team.

The system 10 may further comprise one or more of a weekly semi-final drum 16 (hereinafter “semi-final drum”), a grand prize drum 18, and a hunch play drum 20. It will be apparent from the following detailed description that the semi-final drum 16, the grand prize drum 18, and hunch play drum 20 are configured similar to the team drums 14, except that they may be configured to be a different size. The function of each of the various drums will become apparent from the description of the gaming activities described herein.

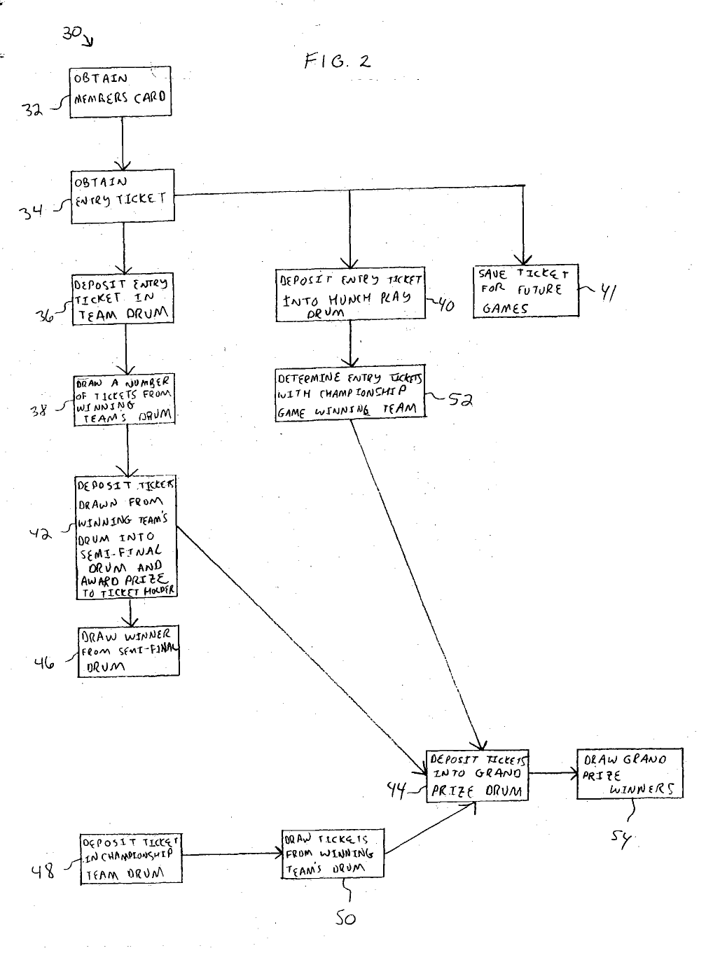

Referring now to drawing FIG. 2, there is shown a flowchart diagramming play of one possible embodiment of the gaming activities of the present invention shown generally at 30. As will be apparent in the following description, the gaming activities described herein combine random drawings, such as lottery type games or other random games of chance, with an outcome of a sporting event between at least two participants. As used herein, the term “sporting event” may be used synonymously with the term “game” and used to refer to a sporting activity, such as a game, between at least two participants. Although the gaming activities are described herein as directed to a sporting event, the invention is not meant to be so limited. Any “separate event” in which at least two participants participate, or compete, are meant to be included within the definition of“game.” Participants may include a team or an individual player that participates in the separate event. The gaming activities described herein may be conducted in three phases, comprising a regular season, a post season, and a grand prize phase. It will be appreciated by those of ordinary skill in the art that a “season” of league sports often includes two parts, comprising a “regular season” where all teams in the league play and a “post season” where teams that qualify for the “post season” compete for the league championship. It will be further appreciated that the post season games and the league championship may be decided by a single game, however the post season and league championship may also be determined by series of games, as known to those of ordinary skill in the art. Thus, the gaming activities described herein may be based on a single game, a series of games, or may be conducted with each game of the series and the entire series.

As shown in FIG. 2, a player may qualify for participation in the illustrated gaming activity by “registering” with a business enterprise, such as a casino, in the illustrated embodiment. To “register,” the player may submit identifiable information to the business enterprise such that the business enterprise is able to identify each player in the gaming activity. As illustrated, the player may register with the business enterprise by obtaining a member club card, at box 32. Member club cards are well known to those of ordinary skill in the art in the gaming industry and comprise a club sponsored by a casino, or other gaming establishment, that patrons to the casino may join. An example of a member club card is a Pala Privileges Club card, sponsored and run by Pala Casino^{SM} of Pala, Calif. Typically, the member club card holder earns credits or other rewards by being a club member and using the member club card when participating in the gaming activities at the casino. Although the gaming activities disclosed herein require the use of a member club card to qualify a player for participation, it will be apparent to those of ordinary skill in the art that players may qualify for participation in the gaming activity described herein in any other manner, including without limitation obtaining an entry certificate, signing up for the gaming activity, visiting a casino, playing a gaming activity, or in any other manner of qualifying players for participation in a gaming activity known by those of ordinary skill in the art. Alternatively, a player may not have to qualify for participation in the gaming activity, but may simply be able to enter the gaming activity.

Referring in conjunction to drawings FIG. 1 and FIG. 2, play of the illustrated gaming activity will be described. It will be appreciated by those of ordinary skill in the art that the gaming activities described herein may be advertised to potential customers throughout various channels of commerce (e.g., newspaper advertisements, radio advertisements, television advertisements, internet advertisements, leaflets, fliers, etc) in order to make potential patrons of the business enterprise promoting the gaming activities aware of the gaming activities. For instance, the business establishment may advertise the gaming activity incorporating a football theme before a football season begins. Once a player registers for participation (e.g., by obtaining a member club card), at box 32, the player may use the club card to obtain an entry ticket, at box 34. The use of entry tickets in lottery type games is well known to those of ordinary skill in the art and any form of entry ticket that obtains identifiable information from a player (e.g., name, address, member club identification number, etc) for participation in a gaming activity is meant to be encompassed by the present invention. In the illustrated embodiment, each player may obtain one entry ticket per day, free of charge, by presenting the player's member club card to a gaming official at the casino or gaming establishment. In order to ensure the gaming activity is run in a fair manner, each player may be required to present their membership club card and a valid identification to claim their entry ticket.

The business enterprise offering the gaming activity 30 may further promote its services by allowing players to obtain additional entry tickets by fulfilling certain requirements. For example, players at a casino may obtain additional entry tickets by playing various casino games at the casino, including, without limitation, electronic games, table games, or any other gaming device used in the gaming industry known to those of ordinary skill in the art. In the illustrated embodiment, players may obtain an additional entry ticket for each credit or award earned with the member club card. For example, players of electronic slot or video games who use members club card, such as a Pala Privileges Club card, have an opportunity to earn extra credits or awards, such as Privileges Dollars at the Pala Casino^{SM}, wherein the extra credits or awards may be used to obtain additional entry tickets. However, rules determining when the additional entry tickets may be obtained or used may be incorporated into the gaming activities. For instance, in the illustrated gaming activities, the player may be required to claim the additional entry tickets by midnight of the day the extra credits or awards are earned and present their members club card and valid identification to obtain the additional entry tickets. Players participating in table games may also obtain additional entry tickets. On the fulfillment of various conditions, additional entry tickets may be distributed to players at various time intervals throughout the day to players who are actively participating in a gaming activity at a table, such as each day at 10 AM, 12 PM, 4 PM, 8 PM, and 10 PM. It will be apparent to those of ordinary skill in the art that there are many other ways and methods for players to obtain additional entry tickets, at box 34, including, but not limited to, winning games played at a casino, placing a specified minimum bet on a casino game, purchasing additional entry tickets, obtaining pre-determined winning combinations on a casino game, or based on other usages of casino services. All such embodiments are within the scope of the present invention.

Once a player obtains an entry ticket, the player may use the entry ticket right away and participate in the gaming activity 30 by depositing the entry ticket into any team drum 14 of a team that the player believes will win a game, at box 36, by depositing the entry ticket into the hunch play drum 20, at box 40, or the player may have the option of using the entry ticket later by saving the entry ticket for subsequent play at a later time, at box 41. For example, if the player thinks that Team A will beat Team B in an upcoming contest, the player may deposit the entry ticket into the team drum 14a of Team A, at box 36. Players may deposit entry tickets into a team drum 14 up until a specified time before the game between Team A and Team B begins, such as until fifteen minutes before kickoff of the football game between the teams. It will be apparent that in addition to selecting a team to win a game between two teams, that other separate events may be used to determine if the player qualifies for participation in the subsequent random drawings. In the separate event, the player may select an outcome of the event and if the player selects a winning outcome of the separate event, then the player is qualified for the random drawing. For instance, the separate event may be a race where the player selects an outcome of the race, such as which participant will win the race or what place a participant will finish in the race. If the outcome of the separate event matches the player's selection, then the player selected a winning outcome and qualifies for the random drawing.

After the game between Team A and Team B concludes, a pre-determined number of winning tickets are drawn from the winning team's drum 14, at box 38. In the illustrated embodiment, the winning team is determined based on the final score of the game. However, if the two teams playing tie, then both teams are declared a winning team. Thus, if Team A were to defeat Team B, the entry tickets in team drum 14a would be randomized by mixing the entry tickets together and the pre-determined number of winning tickets would be drawn 38 and removed from team drum 14a to determine a winner. Of course it will be appreciated that in alternative embodiments, a tie may result as a push allowing players to re-deposit the entry tickets in an alternative game, or both teams may be declared as the losing team.

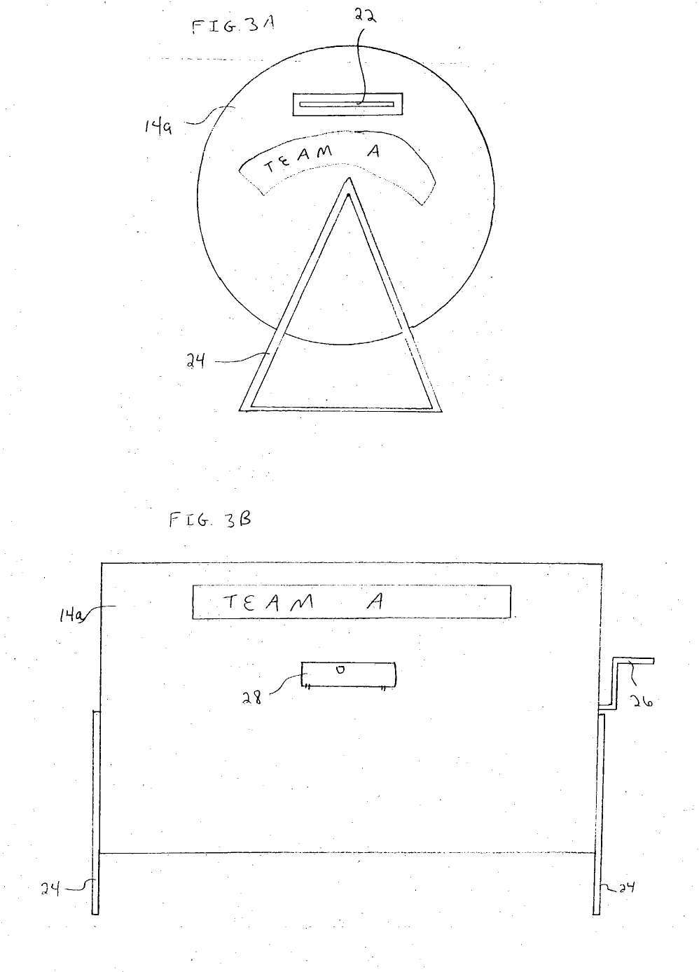

Referring now to drawing FIG. 3A, there is shown a front view of a team drum 14 used in the gaming activities of the present invention. Team drum 14a is illustrated for Team A. As depicted, the team drum 14a includes a slot 22 where entry tickets may be deposited into the team drum 14a and a support 24 for supporting the team drum 14a. Referring now to drawing FIG. 3B, there is shown a side view of the team drum 14a illustrated in FIG. 3A. As depicted, the team drum 14a has a cylindrical shape and has a support 24 on the front and back of the team drum 14a. The team drum 14a further comprises a handle 26 that may be used to rotate the team drum 14a to randomize the entry tickets inside the team drum 14a. The team drum 14a further comprises a door 28 for providing access to the interior of the team drum 14a such that the winning entry tickets may be drawn and removed from the team drum 14a, at box 38, of FIG. 2. Although the illustrated gaming activity depicts the use of a team drum 14 with a handle 26 for randomizing the entry tickets, it will be apparent to those of ordinary skill in the gaming industry that any type of device used to conduct a random drawing, lottery-type game, or any other device or method of determining a winner in a game of chance, such as using a random number generator of a computer system, may be used to select a winner and not depart from the scope of the present invention. If the gaming activities of the present invention are implemented on a computer system, the entry ticket may be generated by a device of the computer system. For instance, the player, or a gaming official, may input the identifiable information identifying the player into a computer system using an input device of the computer system, wherein the computer system prints out an entry ticket that the player may use to play the gaming activities. Alternatively, the computer system may have a magnetic card reader for reading a member's club card of the player where after the player's club card is scanned by the card reader, the computer system prints out the entry ticket that includes the identifiable information from the player.

Referring again in conjunction to drawings FIG. 1 and FIG. 2, during play of the gaming activity in the regular season of the sports league in the illustrated gaming activity 30, a number of entry tickets are randomly drawn from the winning team's drum 14, at box 38. The number of tickets drawn may be any desired number, as outlined in previously determined rules for the gaming activity, which may be sufficient to promote the business, such as ten or twenty. Each of the tickets drawn from the winning team's drum 14 is deposited, at box 42, into the semi-final drum 16 and each player who is identified by one of the winning tickets is awarded a cash prize, such as fifty dollars. Although players win cash prizes in the illustrated embodiment, the players may be awarded any type of prize (e.g., gaming tokens, merchandise, gift certificates, etc) and not depart from the spirit of the present invention. It will be appreciated that the number of tickets drawn from the winning team's drum 14 may be varied in proportion to the value of the prize awarded. Each ticket drawn from the winning team's drum 14 that is deposited into the semi-final drum 16 may also be subsequently deposited into the grand prize drum 18, at box 44. Any entry ticket that is not drawn from a winning team's drum 14 after the conclusion of a game is discarded and becomes, or is rendered, void.

In the illustrated embodiment, three pairs 12 of team drums 14 are depicted, wherein each pair 12 represents a football game to be played on a particular week of the football season. However, in a typical professional football league, the number of games played each week may be different. Notwithstanding the number of games played each week, the number of pairs 12 of team drums 14 used in the gaming activity described herein may represent the number of games played for each week in the football season and winners will be drawn 38 from team drums 14 of the winning team of each pair 12. Thus, if fifteen games are to be played in a given week, there would be fifteen pairs 12 of team drums 14 and twenty winners would be drawn, at box 38, from the drum 14 of each winning team in each pair 12. The winning tickets drawn, at box 38, from the winning teams' drums 14 are deposited, at box 42, into the semi-final drum 16 and the player possessing, or the holder, each winning entry ticket drawn, at box 38, from the winning teams drum 14 is awarded a prize, such as a cash award.

In the illustrated embodiment, each holder of an entry ticket drawn from a winning team's drum 14 has a limited period of time (e.g., one week) to claim their prize. Any unclaimed prize money may be carried over to the grand prize drawing conducted at the end of the season, which will be described subsequently herein. Winners may be notified by posting the first name and club member account number of the holder of the winning entry ticket at the casino. After all the games for the week are completed, all the entry tickets drawn from the winning team's drums 14 are deposited into the semifinal drum 16, at box 42, and one ticket is drawn from the semi-final drum 16, at box 46. The holder of the entry ticket drawn from the semifinal drum 42 is awarded a cash prize. The value of the prize may be stepped based on a selected factor, such as fifteen thousand dollars if the winner is present or ten thousand dollars if the winner is not present at the drawing. This encourages players to be present for the drawing and thus be attracted to the location at which the gaming activity is conducted. If the winner is not present, the extra amount, or a portion thereof, may be carried over to the next week and awarded to the subsequent week's winner until the holder of a winning ticket that has been drawn from the semi-final drum 16 is present. One way to determine if a winner is present is to announce the name of the winner chosen from the semifinal drum 16 over a speaker system and the allow winner ten minutes (or another fixed amount of time) to claim their prize at either the location of the drawing or at a specified claim location within the casino. Once a winner is chosen from the semi-final drum 16, the entry tickets of each of the twenty winners from each pair 12 of drums are deposited into the grand prize drum 18, at box 44.

To add another level of play to the gaming activity, a “hunch play” option may be offered. When this embodiment is included, instead of depositing the entry tickets into the team drum 14, a player may choose to deposit the entry ticket into the hunch play drum 20, at box 40. If the player deposits the entry ticket into the hunch play drum 20, the player needs to indicate on the entry ticket which team in the league the player thinks will win the league championship at the end of the season. If the team that the player selects wins the league championship, then the player's entry ticket is deposited into the grand prize drum 18, at box 44. All other entry tickets are discarded and become void. However, players wishing to deposit entry tickets into the hunch play drum 20 must do so before the end of the regular season because the hunch play drum 20 closes at the end of the regular season. Further, entry tickets placed in the hunch play drum 20 are not available to use to participate in the championship game drawing. The hunch play option may also have an added variation where the number of entries that a player may place in the hunch play drum 20 is weighted based on the length the regular season has progressed. For instance, early in the regular season, players may be able to place more entries (e.g., sixteen entries in week one) in the hunch play drum 20 and as the regular season progresses, the number of entries players may place in the hunch play drum 20 is reduced (e.g., one entry is week sixteen).

In-continued reference to drawings FIG. 1 and FIG. 2, play of the post season of the sports league will be described. As previously described herein, the post season of league play typically begins after the regular season ends, where a fewer number of teams participate for the opportunity to play for the league championship. Play of the gaming activity, at box 30, in the post season is similar to the regular season, except that the players are no longer able to deposit, at box 40, entry tickets into the hunch play drum 20. During the post season, the player deposits, at box 36, their entry ticket into the team drum 14 of the team that the player thinks will win the postseason game in a manner similar to the play during regular season, wherein each post season game is represented by a pair 12 of team drums 14. Once the postseason game is concluded, a pre-determined number of entry tickets are drawn from the team drum 14 of the team that wins the post season game, at box 38. Each player who has their entry ticket drawn wins a cash award, such as fifty dollars, and has their winning ticket deposited into the semi-final drum 16, at box 42. The twenty winners from each game in the post season will have their first name and privileges card posted at the casino and have one week to claim their prize. If the winner does not claim their cash prize, the cash award is carried over and subsequently distributed in the grand prize drawing. A winning entry ticket is then drawn from the semi-final drum 16, at box 46, where the holder of the winning ticket is awarded a cash prize. The value of the prize may be stepped based on a selected factor, such as fifteen thousand dollars if the winner is present or ten thousand dollars if the winner is not present at the drawing. This encourages players to be present for the drawing and, thus, to be attracted to the business. If the winner is not present, the extra amount may be carried over to the next week and awarded to the subsequent week's winner until a weekly winner is present or, if no winner is present, the cash award may be carried over to the grand prize drawing. It will be appreciated that where the post season for the team league is operated by a series of playoff games between the teams, as in professional hockey, professional baseball, or professional basketball, the drawings may be based on each game in a series or on the series as a whole.

In the gaming activity 30 of the present invention, the post season continues until the number of teams remaining is two, where the last two teams will play in a championship game. Up until a predetermined time (e.g., fifteen minutes before kickoff of the championship game), players are able to deposit entry tickets into one of the team drums 14 of the two teams playing in the championship game, at box 48. It will be apparent that in the illustrated gaming activity the start of the championship game is the last opportunity for players to use their entry tickets because once the championship game ends, the football season is over. However, any predetermined period of time, date, or week in the regular or post season may be used as a cutoff time for players to use any saved tickets and not depart from the spirit of the present invention. Thus, players who have saved entry tickets throughout the regular and post seasons may deposit the saved entry tickets into one, or both, of the team drums 14 of the two teams participating in the championship game. It will be appreciated that where the championship game is operated by a series of games between the teams, as in professional hockey, professional baseball, or professional basketball, the drawings may be based on each game in a series, or on the series as a whole.

Once the championship game has concluded, a pre-determined number of entry tickets, such as twenty in the illustrated embodiment, are drawn from the team drum 14 of the team that wins the championship game, at box 50. One holder of the entry ticket drawn will win a large cash award, such as twenty five thousand dollars, while the other holders of the entry tickets will each receive a smaller cash award, such as fifty dollars. To claim the cash prize after the championship game, the player must be present to win. If the cash prize awarded after the championship game is not claimed within ten minutes of the winning entry ticket being drawn 50, another entry ticket is drawn from the team drum 14 of the winning team until a winner is present. The pre-determined number of tickets drawn from the winning team of the championship game will be deposited into the grand prize drum 18, at box 44.

After the championship game has concluded, the entry tickets in the hunch play drum 20 are analyzed to determine which entry tickets in the hunch play drum 20 have the name of the team that won the championship game designated on the entry ticket, at box 52. The entry tickets in the hunch play drum 20 with the name of the team that won the championship game are then deposited into the grand prize drum 18, at box 44.

It will be apparent that qualification for the grand prize may be accomplished in the regular and post seasons by being a weekly prize winner (e.g., selecting a winning team and having the entry ticket drawn) or by choosing the correct team that wins the championship game and depositing the entry ticket in the hunch play drum 20. At a pre-determined time after the post season is completed, a number of grand prize winners are drawn from the grand prize drum 18, at box 54. It will be apparent to those of ordinary skill in the art that the grand prize drum 18 may be configured similar to the team drum 14a of drawings FIG. 3A and 3B, but may be larger. Any selected number of winners may be chosen and the prizes may vary based upon selection order. For example, if thirty-six winners are chosen, one winner will win a large cash prize of one-hundred thousand dollars, five winners will each win twenty-five thousand dollars, ten winners will each win ten thousand dollars, and twenty winners will each win five thousand dollars. It will be apparent to those of ordinary skill in the art that any number of winners may be may be drawn in the grand prize drawing and not depart from the spirit of the present invention. For instance, there may be more five thousand dollars winners if there is any unclaimed prize money from players not claiming their previously determined prizes during the regular or post seasons. Alternatively, all winners selected may receive the same prize.

It will be apparent that the gaming activities 30 described herein allow each player participating in the gaming activity 30 to select from a nearly endless number of different strategies of how each player may play the game, thus making the player's gaming experience more interactive and entertaining. In illustrated gaming activity, there are two ways to qualify for the grand prize drawing, by either being a weekly prize winner or selecting the right team to win the championship game in the hunch play drum 20. Thus, each player's strategy in selections may have an impact on whether the player wins or loses because the player's selection of which team will win each game determines, at least in part, whether the player will have a chance at being drawn to win an award. For instance, the player may play the gaming activities by selecting the “favorite” team in a game, wherein the player selects a team favored to win a particular game. Although most of the other players may also select the team favored to win, each player will have the same odds of being selected as a winner when the entry tickets are drawn from the winning team's drum. The player may also select the “longshot” or the team favored to lose. In this strategy, there will not be as many players selecting the team favored to lose, but if the team favored to lose wins, the player may have a better chance of winning because, at least theoretically, there will be a fewer number of entry tickets in the winning team's drum 14. The player may opt for a “go-for-it” strategy where the player places a plurality of entry tickets into one team drum 14. Thus, if the team selected by the player wins, the player has a better shot of being selected a winner since the player will have more entry tickets in that team's team drum 14. In another strategy, the player may select a “week-of-destiny” where the player saves a number of entry tickets from previous weeks in anticipation for one particular game and deposits all entry tickets into the team drum 14 of the team that the player believes will win, thus increasing the odds of having an entry ticket drawn if the selected team wins. In yet another strategy, the player may opt for the “super hunch” play by selecting the name of a team and depositing the entry ticket in the hunch play drum 20. Thus, although some possible strategies have been described above, it will be apparent by those of ordinary skill in the art that the player may use many different strategies in an attempt to be selected as a winner. However, the more entry tickets a player deposits into various drums, the better their odds are for winning.

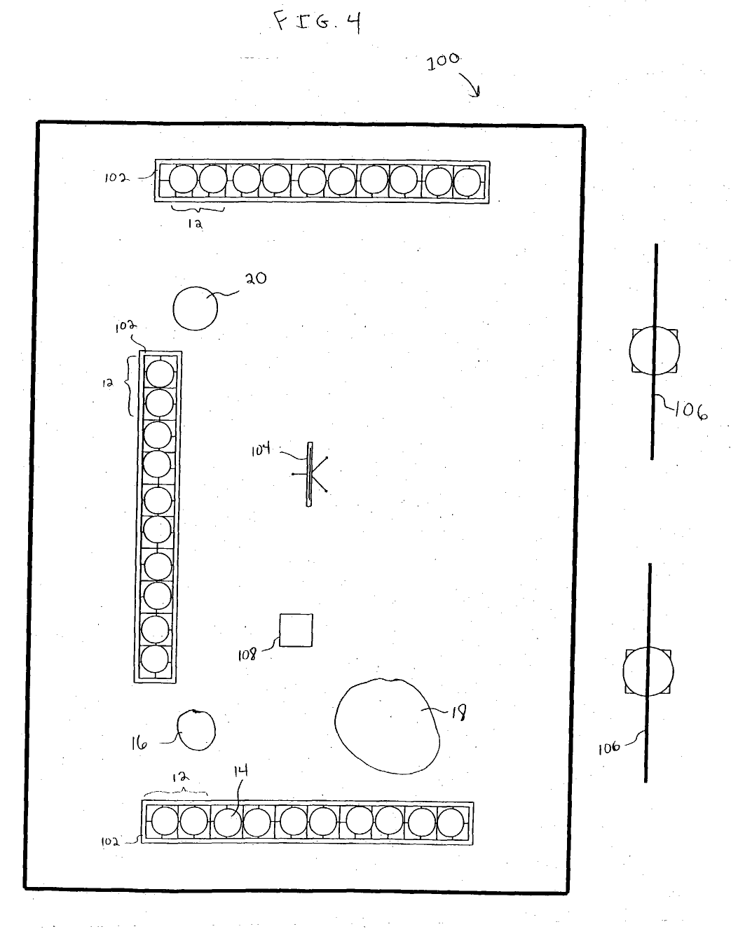

Referring now to drawing FIG. 4, there is shown a diagrammatic representation of a system used to conduct the gaming activity 30 of the present invention in a casino, or gaming establishment, generally at 100. As illustrated, there are three over-sized benches 102. On top of each of the over-sized benches 102 rests five pairs 12 of team drums 14. A hunch play drum 20, a semi-final drum 16, and a grand prize drum 18 are also illustrated in the system 100. An A-frame 104 and two sets of goal posts 106 are also illustrated as promotional materials used to advertise and promote the gaming activity 30 disclosed herein. The system 100 further includes a stand 108 for posting the names of winners during the gaming activity 30.

The system 100 may also include a rule book that conveys how the game is played to the players. In the illustrated gaming activity 30 where a football theme is used, the rule book may be referred to as an “official playbook” in keeping with the football theme. The rule book may also spell out other rules and regulations of how the gaming activity 30 is conducted including without limitation eligibility criteria for the participants; applicable federal, state, and local taxes; times, dates, and locations where drawings are to be held; and any other rules that may be applicable as is well known to those of ordinary skill in the art.

It will be apparent that although the gaming activity 30 described herein has been implemented using team drums 14 and entry tickets to select winners, it will be appreciated by those of ordinary skill in the art that other gaming methods and devices may be used. For instance, winners may be chosen with a random selection means that uses any kind of random drawing, lottery-type drawing, random selection process, or a random number generator, such as a central processing unit of a computer system or network, as is known by those of ordinary skill in the art. In addition to using entry tickets for allowing players to participate, players may participate by entering identifiable information and selections of which teams the players think may win in a computer system or network.

It will be appreciated by those of ordinary skill in the art that the embodiments described herein are not intended to limit the invention of the scope of the appended claims. Various combinations and modifications of the embodiments described herein may be made without departing from the scope of the present invention and all modifications are meant to be included within the scope of the present invention.

Thus, while certain illustrative embodiments and details have been described for purpose of illustrating the invention, it will be apparent to those of ordinary skill in the art that various changes in the invention described herein may be made without departing from the scope of the present invention, which is defined in the appended claims.

1. A method of conducting a gaming activity, comprising: providing at least one player an opportunity to participate in a gaming activity, said
opportunity comprising providing said at least one player with an opportunity to
select an outcome of a separate event; qualifying said at least one player that selects a winning outcome in said separate event
for participation in a first random drawing; and determining at least one first winner in said first random drawing.

2. The method according to claim 1, further comprising:
qualifying said at least one first winner in said first random drawing for participation in a second random drawing; and
determining at least one second winner in said second random drawing.

3. The method according to claim 1, wherein said opportunity to participate in said gaming activity further comprises requiring said at least one player to register to participate in said gaming activity.

4. The method according to claim 1, further comprising:
qualifying said at least one first winner in said first drawing for participation in a third random drawing; and
determining at least one third winner in said third random drawing.

5. The method according to claim 1, wherein said opportunity to participate in said gaming activity further comprises:
providing said at least one player an opportunity to select a participant to win a league championship;
responsive to an outcome of said league championship, qualifying said at least one player that selected a winning participant in said league championship for participation in a third random drawing; and
determining a winner of said third random drawing.

6. The method according to claim 1, wherein said opportunity to participate in said gaming activity further comprises:
providing said at least one player an opportunity to select an outcome a league championship game;
qualifying said at least one player that selected a winning outcome of said league championship game for participation in a third random drawing; and
determining a winner of said third random drawing.

7. The method according to claim 1, wherein providing said at least one player said opportunity to select said outcome of said separate event comprises:
distributing at least one entry ticket to said at least one player;
providing at least one drum; and
allowing said at least one player to select said outcome by depositing said at least one entry ticket in said at least one drum.

8. The method according to claim 7, wherein determining said at least one winner in said first random drawing comprises:
randomizing said at least one entry ticket deposited in said at least one drum corresponding to said winning outcome; and
drawing at least one entry ticket from said at least one drum corresponding to said winning outcome.

9. The method according to claim 1, wherein providing said at least one player said opportunity to select said outcome comprises allowing said at least one player to select at least one team participating in a sporting event.

10. The method according to claim 1, further comprising awarding a first prize to said at least one first winner in said first random drawing.

11. The method according to claim 2, further comprising awarding a second prize to said at least one second winner in said second random drawing.

12. The method according to claim 4, further comprising awarding a third prize to said at least one third winner in said third random drawing.

13. The method according to claim 1, further comprising conducting said gaming activity in conjunction with a business enterprise.

14. A method of conducting a gaming activity, comprising:
providing at least one player a first opportunity to participate in a gaming activity, said first opportunity comprising allowing said at least one player to select a participant to win a league championship;
qualifying said at least one player that selected a winning participant in said league championship for participation in a first random drawing;
determining at least one winner in said first random drawing; and
awarding a prize to said at least one winner.

15. The method according to claim 14, further comprising:
providing said at least one player a second opportunity to participate in said gaming activity, said second opportunity comprising allowing said at least one player to select an outcome of a separate event;
qualifying said at least one player that selects a winning outcome in said separate event for participation in a second random drawing; and
determining at least one second winner in said second random drawing.

16. The method according to claim 14, further comprising:
providing said at least one player a third opportunity to participate in said gaming activity, where in said third opportunity comprises allowing said at least one player to select a participant in a championship game; and
if said at least one player selects the participant that wins said championship game, qualifying said at least one player for participation in said first random drawing.

17. The method according to claim 14, further comprising:
qualifying said at least one winner in said first random drawing for participation in a second random drawing;
determining at least one winner in said second random drawing;
qualifying said at least one winner in said first random drawing for participation in a third random drawing; and
determining at least one winner in said third random drawing.

18. The method according to claim 14, wherein said first opportunity to participate in said gaming activity further comprises:
distributing at least one entry ticket to said at least one player; and
allowing said at least one player to indicate on said at least one entry ticket said participant selected to win said league championship.

19. The method according to claim 18, further comprising:
providing at least one drum for receiving said at least one entry ticket;
depositing said at least one entry ticket of said at least one player that selected said winning participant in said league championship into said at least one drum; and
wherein determining said at least one winner in said first random drawing comprises randomly selecting said at least one entry ticket from said at least one drum.

20. The method according to claim 15, wherein said second opportunity further comprises:
providing at least one drum, wherein said at least one drum represents a participant in said separate event; and
providing said at least one player at least one entry ticket, wherein said at least one player selects said outcome by depositing said at least one entry ticket in said at least one drum of said participant that said at least one player selects.

21. The method according to claim 16, wherein said third opportunity further comprises:
distributing at least one entry ticket to said at least one player;
providing at least one drum, wherein said at least one drum represents a team participating in said championship game;
allowing said at least one player to deposit said entry ticket into said at least one drum of said team that said at least one player selects to win said championship game; and
conducting said first random drawing by randomizing said at least one entry ticket in a drum representing a winning team in said championship game and drawing a winning entry ticket from said drum representing said winning team.

22. The method according to claim 14, further comprising conducting said gaming activity in conjunction with a business enterprise.

23. A system for conducting a gaming activity, comprising:
at least one identification means for accepting identifiable information from at least one player;
a first random selection means, said first random selection means configured for randomly selecting a first winner;
a second random selection means, said second random selection means configured for randomly selecting a second winner; and
a third random selection means, said third random selection means configured for randomly selecting a third winner.

24. The system of claim 23, wherein said at least one identification means comprises an entry ticket.

25. The system of claim 24, wherein said first random selection means comprises at least one first rotatable drum, said second random selection means comprises at least one second rotatable drum, and said third random selection means comprises at least one third rotatable drum.

26. The system of claim 23, further comprising a set of rules for conducting said gaming activity.

27. The system of claim 25, wherein said at least one first rotatable drum is configured with indicia of a sporting event.

28. The system of claim 23, further comprising at least one promotional material configured for promoting a gaming activity incorporating a sports theme.

29. The system of claim 23, further comprising a members club.

30. The system of claim 23, further comprising at least one gaming device configured to conduct a casino game.

31. The system of claim 23, further comprising a computer system, wherein a random number generator of said computer system is configured as said first random selection means, said second random selection means and said third random selection means.

32. The system of claim 31, wherein said identification means comprises an input device of said computer system.
